(19) United States
(12) Patent Application Publication
(10) Pub. No.: US 2013/0309423 A1
(43) Pub. Date: Nov. 21, 2013

(54) Composition for Conductive Transparent Film

(71) Applicants: Stéphane Roger, Pannes (FR); Marie Dieudonné, Laguiole (FR); Alexandre Marchat, Avon (FR); Philippe Sonntag, Avon (FR)

(72) Inventors: Stéphane Roger, Pannes (FR); Marie Dieudonné, Laguiole (FR); Alexandre Marchat, Avon (FR); Philippe Sonntag, Avon (FR)

(73) Assignee: HUTCHINSON, Paris (FR)

(21) Appl. No.: 13/876,912

(22) PCT Filed: Sep. 29, 2011
(86) PCT No.: PCT/IB2011/054283

§ 371 Date: Jun. 17, 2013

(30) Foreign Application Priority Data
Sep. 29, 2010 (FR) 10 03858

(51) Int. Cl. H01B 1/24

(52) U.S. Cl. CPC H01B 1/24
USPC 428/1.4; 174/126.1; 252/511; 428/419; 428/412

(57) ABSTRACT

The present invention relates to a novel polymer composition having conductive properties comprising: (a) at least one dispersion or suspension of elastomer having a T_{g}<20° C. and/or of thermoplastic polymer having a T_{g}<20° C., and/or a polymer solution, (b) at least one optionally substituted polythiophene conductive polymer, (c) particles of crosslinked or uncrosslinked polymer chosen from functionalized or unfunctionalized particles of polystyrene, of polycarbonate, of polymethylene melamine, said un crosslinked polymer particles having a T_{g}>80° C., glass particles, silica particles, and/or particles of metal oxides chosen from the following metal oxides: ZnO, MgO, MgAl₂O₄, and borosilicate particles. A process for preparing such a composition, a conductive transparent film resulting from the film formation of such a composition, a process for preparing such a film, and also articles, and more particularly electronic devices, coated with such a composition or with such a film are, also part of the invention.

The present invention relates to a novel polymer composition having conductive properties, to a process for the preparation of such a composition, to a conductive transparent film resulting from the film formation of such a composition, and to a process for the preparation of such a film. Articles, and more particularly electronic devices, coated with such compositions or with such films also come within the invention.

Conductive transparent electrodes exhibiting both high electrical conductivity properties and transmission currently form the subject of considerable developments in the field of electronic equipment, electrodes of this type being increasingly used in photovoltaic cells, liquid crystal display panels, touch screens, organic light emitting diodes (OLEDs) or polymer light emitting diodes (PLEDs).

The majority of conductive transparent films currently used are based on carbon nanotubes, the latter being prepared from polymeric dispersions filled with carbon nanotubes. The preparation of these dispersions requires the use of dispersants (carbon nanotubes being difficult to disperse alone), the latter being insulating organic materials which, once incorporated in the composition, greatly reduce the conductivity of the film obtained. In order to overcome this problem, the proposal has been made to wash the resulting films, so as to remove a portion of the dispersant used (the complete removal of the dispersant being very difficult). However, this washing stage makes the process used more difficult to implement.

Some solutions of the state of the art also provide mixtures of carbon nanotubes dispersed in conductive polymers. However, it appears that the conductive polymers used are greatly damaging to the transparency of the film, these polymers generally exhibiting the disadvantage of being highly colored and not very transparent. Thus, only very thin layers, the thickness of which it is difficult to control, can be deposited on the substrates (the thickness of these layers not being able to exceed 200 to 300 nm), these very thin deposits requiring substrates having a very low roughness (arithmetic roughness Ra<50 nm). This is the case with the compositions disclosed in the documents WO 2006/137846 and U.S. Pat. No. 6,984,341, the latter disclosing in particular compositions obtained from aqueous dispersions of polythiophene and of polyanionic compounds, such as polystyrenesulfonates, in the presence of additional additives chosen from ketals, lactones, carbonates, cyclic oxides, diketones, anhydrides, aminocarbonic acids, phenols and inorganic acids.

Application US 2009/0252967 relates to novel transparent electrodes comprising a first layer essentially composed of carbon nanotubes, covered with a second polymeric layer filled with conductive particles, the electrodes obtained exhibiting an improved electrical conductivity and an improved roughness. Nevertheless, the process for the manufacture of these electrodes remains complex, insofar as it requires a stage of washing the layer of carbon nanotubes, and also the application of a second polymeric layer.

Other compositions simultaneously comprising an elastomer and/or a thermoplastic polymer, a conductive polymer and conductive or semiconductive fillers have also been described in the prior art (applications WO 2009/117460, US 2010/0116527, EP 2 036 941 and WO 2010/112680). However, the transparency and the transmission of the films obtained after drying these compositions still remains to be optimized.

The inventors have now found, surprisingly, that it is possible to even more significantly improve the transparency and the transmission of the films resulting from such compositions by the addition of structuring particles, it being possible for the latter to be particles having a specific nature and/or metal oxide particles. This is because the addition of such structuring particles makes it possible to tighten up the conductive network and thus to obtain polymer compositions exhibiting an improved transparency and an improved electrical conductivity.

In addition, the compositions of the invention are prepared according to a process which is simple to implement, in comparison with the processes described in the prior art, said process not involving additional stages of washing or of application of additional polymeric layers. This is in fact a compromise in performances which is difficult to achieve, all these advantages being obtained without negatively affecting the electrical properties of the film or of the conductive coating obtained, indeed even while introducing significant improvements in terms of transparency and conductivity.

More particularly, the compositions of the invention meet the following requirements and properties:
an electrical resistance R<1000 Ω/□,
a transparency T>78%,
an excellent flexibility,
   the compositions of the invention being able to be applied as thick layers (which can reach thicknesses of 15 μm) and being very easy to employ.

Thus, the first subject matter of the present invention is a composition comprising:

(a) at least one dispersion or suspension of elastomer having a Tg<20° C. and/or of thermoplastic polymer having a Tg<20° C., and/or one polymer solution,

(b) at least one optionally substituted polythiophene conductive polymer,

(c) particles of crosslinked or noncrosslinked polymer chosen from functionalized or nonfunctionalized particles of polystyrene, of polycarbonate or of polymethylenemelamine, said particles of noncrosslinked polymer exhibiting a Tg>80° C., particles of glass, particles of silica and/or particles of metal oxides chosen from the following metal oxides: ZnO, MgO or MgAl₂O₄, or particles of borosilicate, it being possible for said particles (c) to be provided either in the form of a powder or in the form of a dispersion in water and/or in a solvent,

(d) conductive or semiconductive fillers which are nanometric in one or two dimensions, in dispersion or in suspension in water and/or in a solvent, said fillers preferably exhibiting a shape factor (length/diameter ratio)>10.

The composition of the invention can comprise each of the constituents (a), (b), (c) and (d) in the following proportions by weight (for a total of 100% by weight):

(a) from 5 to 99% by weight and preferably from 50 to 99% of at least one dispersion or suspension of elastomer having a Tg<20° C. and/or of thermoplastic polymer having a Tg<20° C., and/or one polymer solution,

(b) from 0.01 to 90% by weight and preferably from 0.1 to 20% of at least one optionally substituted polythiophene conductive polymer,

(c) from 0.1 to 90% by weight and preferably from 1 to 50% of particles of crosslinked or noncrosslinked polymer chosen from functionalized or nonfunctionalized particles of polystyrene, of polycarbonate or of polymethylenemelamine, said particles of noncrosslinked polymer exhibiting a Tg>80° C., of particles of glass, of particles of silica and/or of particles of metal oxides chosen from the following metal oxides: ZnO, MgO or MgAl₂O₄, or of particles of borosilicate,

(d) from 0.01 to 90% by weight and preferably from 0.1 to 10% of conductive or semiconductive fillers which are nanometric in one or two dimensions, in dispersion or in suspension in water and/or in a solvent.

According to an advantageous embodiment, the composition of the invention comprises at least one dispersion or suspension (a) of elastomer, said elastomer preferably being chosen from polybutadiene, polyisoprene, acrylic polymers, polychloroprene, it being possible for the latter to optionally be a sulfonated polychloroprene, polyurethane, hexafluoropropene/difluoropropene/tetrafluoroethylene terpolymers, copolymers based on chlorobutadiene and on methacrylic acid or based on ethylene and on vinyl acetate, SBR (Styrene Butadiene Rubber), SBS (Styrene Butadiene Styrene), SIS (Styrene Isoprene Styrene) and SEBS (Styrene Ethylene Butylene Styrene), isobutylene/isoprene copolymers, butadiene/acrylonitrile copolymers or butadiene/acrylonitrile/methacrylic acid terpolymers. More preferably still, the elastomer is chosen from acrylic polymers, polychloroprene, SBR copolymers and butadiene/acrylonitrile copolymers.

According to another advantageous embodiment, the composition of the invention can comprise at least one dispersion or suspension (a) of thermoplastic polymer, said thermoplastic polymer being chosen from polyesters, polyamides, polypropylene, polyethylene, chlorinated polymers, such as polyvinyl chloride and polyvinylidene chloride, fluorinated polymers, such as polyvinylidene fluoride (PVDF), polyacetates, polycarbonates, polyetheretherketones (PEEKs), polysulfides or ethylene/vinyl acetate copolymers.

According to another preferred embodiment, the composition of the invention can comprise at least one polymer solution (a), said polymer being chosen from polyvinyl alcohols (PVOHs), polyvinyl acetates (PVAs), polyvinylpyrrolidones (PVPs) or polyethylene glycols.

Said elastomer and/or said thermoplastic polymer are used in the form of a dispersion or of a suspension in water and/or in a solvent, said solvent preferably being an organic solvent chosen from dimethyl sulfoxide (DMSO), N-methyl-2-pyrrolidone (NMP), ethylene glycol, tetrahydrofuran (THF), dimethyl acetate (DMAc) or dimethylformamide (DMF). Preferably, the elastomer and/or the thermoplastic polymer are in dispersion or in suspension in water.

The conductive polymer (b) is a polythiophene, the latter being one of the most thermally and electronically stable polymers. A preferred conductive polymer is poly(3,4-ethylenedioxythiophene)-poly(styrenesulfonate) (PEDOT: PSS), the latter being stable towards light and towards heat, being easy to disperse in water and not exhibiting environmental disadvantages.

The conductive polymer (b) can be provided in the form of granules or of a dispersion or of a suspension in water and/or in a solvent, said solvent preferably being a polar organic solvent chosen from dimethyl sulfoxide (DMSO), N-methyl-2-pyrrolidone (NMP), ethylene glycol, tetrahydrofuran (THF), dimethyl acetate (DMAc) or dimethylformamide (DMF), the conductive polymer (b) preferably being in dispersion or in suspension in water, dimethyl sulfoxide (DMSO) or ethylene glycol.

Organic compounds also known as “conductivity enhancers”, the latter making it possible to improve the electrical conductivity of the conductive polymer, can also be added to the composition of the invention. These compounds can in particular carry dihydroxy, polyhydroxy, carboxyl, amide and/or lactam functional groups, such as the compounds mentioned in the patents U.S. Pat. No. 5,766,515 and U.S. Pat. No. 6,984,341, which are incorporated here by reference. The most preferred organic compounds or “conductivity enhancers” are sorbitol and glycerol.

According to a particularly preferred embodiment of the invention, the particles of crosslinked or noncrosslinked polymer (c) have a mean diameter of between 30 and 1000 nm and more preferably still are chosen from polystyrene particles having a mean diameter of between 30 and 1000 nm. The distribution in the sizes of these polymer particles can be multimodal and preferably bimodal.

Said polymer particles (c) can be used in the form of a powder or of a dispersion or of a suspension in water and/or in a solvent chosen from the following polar organic solvents: dimethyl sulfoxide (DMSO), N-methyl-2-pyrrolidone (NMP), ethylene glycol, dimethyl acetate (DMAc), dimethylformamide (DMF), acetone and alcohols, such as methanol, ethanol, butanol and isopropanol, or a mixture of these solvents.

The fillers (d) can be conductive fillers chosen from nanoparticles and/or nanofilaments of silver, of gold, of platinum and/or of ITO (Indium Tin Oxide), and/or semiconductive fillers chosen from carbon nanotubes and graphene-based nanoparticles. According to a preferred embodiment, the fillers (d) are carbon nanotubes in dispersion in water and/or in a solvent chosen from the following polar organic solvents: dimethyl sulfoxide (DMSO), N-methyl-2-pyrrolidone (NMP), ethylene glycol, dimethyl acetate (DMAc), dimethylformamide (DMF), acetone and alcohols, such as methanol, ethanol, butanol and isopropanol, or a mixture of these solvents.

The ratio by weight of the elastomer and/or the thermoplastic polymer and/or the polymer (a) to the particles (c) can be between 0.1 and 10,000 and preferably between 1 and 1000. The ratio by weight of the conductive polymer (b) to the particles (c) can, for its part, be between 0.01 and 10,000 and preferably between 0.1 and 500. As regards the ratio by weight of the elastomer and/or the thermoplastic polymer and/or the polymer (a) to the nanometric conductive or semiconductive fillers (d), this ratio can be between 1 and 1000 and preferably between 50 and 500. All the ratios by weight indicated are given by weight of dry matter.

Additives, such as ionic or nonionic surfactants, wetting agents, rheological agents, such as thickening agents or liquefying agents, adhesion promoters, colorants or crosslinking agents can also be added to the composition of the invention in order to improve or to modify the performance thereof as a function of the final application targeted.

Another subject matter of the invention relates to a process for the preparation of a composition according to the invention comprising the following stages:

(i) the dispersing or the suspending of the nanometric conductive or semiconductive fillers (d) in water and/or in a solvent, it being possible for said solvent to be a polar organic solvent chosen from dimethyl sulfoxide (DMSO), N-methyl-2-pyrrolidone (NMP), ethylene glycol, dimethyl acetate (DMAc), dimethylformamide (DMF), acetone and alcohols, such as methanol, ethanol, butanol and isopropanol, or a mixture of these solvents,

(ii) the mixing of the dispersion or suspension obtained in stage (i) with a polythiophene conductive polymer (b) which can be provided in the form of granules or of a dispersion or suspension in water and/or in a solvent, said solvent being able to be a polar organic solvent miscible with the solvent used during stage (i) and being able to be chosen from dimethyl sulfoxide (DMSO), N-methyl-2-pyrrolidone (NMP), ethylene glycol, dimethyl acetate (DMAc), tetrahydrofuran (THF) or dimethylformamide (DMF),

(iii) the adding of particles of crosslinked or noncrosslinked polymer (c) to the dispersion obtained in stage (ii), said particles being able to be provided in the form of a powder or of a dispersion or of a suspension in water and/or in a polar organic solvent miscible with the solvent used during stages (i) and (ii) and being able to be chosen from dimethyl sulfoxide (DMSO), N-methyl-2-pyrrolidone (NMP), ethylene glycol, dimethyl acetate (DMAc), dimethylformamide (DMF), acetone and alcohols, such as methanol, ethanol, butanol and isopropanol, or a mixture of these solvents, said particles being chosen from functionalized or nonfunctionalized particles of polystyrene, of polycarbonate or of polymethylenemelamine, said particles of noncrosslinked polymer exhibiting a Tg>80° C., particles of glass, particles of silica and/or particles of metal oxides chosen from the following metal oxides: ZnO, MgO or MgAl₂O₄, or particles of borosilicate,

(iv) the mixing of the dispersion obtained in stage (iii) with at least one dispersion or suspension of elastomer having a Tg<20° C. and/or of thermoplastic polymer having a Tg<20° C., and/or a polymer solution (a).

An additional subject matter of the present invention is a conductive transparent film resulting from the film formation of at least one polymer composition as defined according to the invention. The composition of the invention can thus be deposited on a support, according to any method known to a person skilled in the art, the most widely used techniques being spray coating, inkjet coating, dip coating, film drawer coating, spin coating, impregnation coating, slot die coating, scraper coating or flexographic coating, this being done so as to obtain a film having a thickness which can be between 300 nm and 15 μm. The surface resistance of said film can be between 0.1 and 1000 Ω/□ and preferably between 0.1 and 500 Ω/□ and its mean transmission over a UV-visible [300 nm-900 nm] spectrum can be greater than or equal to 78% and preferably greater than or equal to 80%.

The conductive transparent film of the invention can be prepared according to a process comprising the following stages:

(i′) the application to a support of a composition as defined according to the invention, and

(ii′) the evaporation of the solvents by drying at a temperature of between 25 and 80° C., for a period of time which can be between 10 and 60 minutes, said drying temperature necessarily having to be, when the particles of polymer (c) are particles of noncrosslinked polymer, less than the glass transition temperature Tg of said particles of noncrosslinked polymer present in the composition applied during stage (i′), this condition relating to the drying temperature making it possible to avoid the coalescence and the diffusion of the particles (c) within the composition and thus to contribute good mechanical strength to the final film.

Finally, a final subject matter of the invention relates to an article comprising at least one flexible or rigid substrate coated with a composition as defined according to the invention or with a film as defined according to the invention, it being possible for said substrate to be chosen from glass, metal and flexible polymers, such as polyethylene terephthalate (PET), polyethylene naphthalate (PEN), polyethersulfone (PES), polycarbonate (PC), polysulfone (PSU), phenolic resins, epoxy resins, polyester resins, polyimide resins, polyetherester resins, polyetheramide resins, polyvinyl acetate, cellulose nitrate, cellulose acetate, polystyrene, polyolefins, polyamide, aliphatic polyurethanes, polyacrylonitrile, polytetrafluoroethylene (PTFE), polymethyl methacrylate (PMMA), polyarylate, polyetherimides, polyetherketones (PEKs), polyetheretherketones (PEEKs) and polyvinylidene fluoride (PVDF), the most preferred flexible polymers being polyethylene terephthalate (PET), polyethylene naphthalate (PEN) and polyethersulfone (PES). The article of the invention can be coated with one or more layers of the composition as defined according to the invention.

In order to improve the conductivity of the final product, the flexible or rigid substrate present in the article as defined according to the invention can be coated with a conductive metal mesh, it being possible for the latter to be of gold, of silver or of platinum, or with a mesh of self-assembled conductive metal particles and/or filaments, it being possible for these to be of gold, of silver or of platinum. Said mesh can have a thickness of between 0.01 and 1 μm. The conductive metal mesh can be deposited according to an evaporation technique (PVD-CVD) or a printing technique, such as slot die coating, scraper coating or engraved roll coating.

According to another alternative, the composition of the invention can be deposited on a flexible or rigid transfer substrate, before being transferred onto one of the flexible or rigid substrates listed above. The transfer substrate can be chosen from silicone-comprising or fluorinated films of polyethylene terephthalate (PET), of polyethylene naphthalate (PEN) or of polyethersulfone (PES) and the transfer of said film onto one of the flexible or rigid substrates can be carried out by rolling.

The article of the invention can be an electronic device chosen from photovoltaic cells, liquid crystal display panels, touch screens, flexible display panels, luminous display panels, electrophoretic display panels, organic light-emitting diodes (OLEDs), polymer light-emitting diodes (PLEDs) and electromagnetic shielding devices.

In addition to the preceding arrangements, the invention also comprises other arrangements which will emerge from the remainder of the description which follows, which relates to examples demonstrating the properties of the compositions of the invention.

### I/Starting Materials

TABLE I

| Compound | Chemical nature | Supplier |
|---|---|---|
| MWNTs | Carbon nanotubes | Arkema |
| Graphistrength | | |
| U100 ® | | |
| DMSO | Dimethyl sulfoxide | Merck |
| Clevios PH500 ® | Poly(3,4-ethylenedioxythiophene)- | H C Starck |
| | poly(styrenesulfonate) | |
| | (PEDOT:PSS) dispersion | |
| PS00400-NS | Dispersion of polystyrene | Nanosyslab |
| | nanoparticles | |
| | (Ø = 400 nm; Tg = 108° C.) | |
| Synthomer 5130 ® | Butadiene/acrylonitrile elastomer | Synthomer |

### II/Characterization Methods

1—Measurement of the Thickness of the Film

The thickness of the conductive transparent films is measured on 50×50 mm test specimens using a Veeco Dektak 150 profilometer, by scanning the surface using the tip of the profilometer over a length of between 5 and 10 mm.

The measurements are carried out three times on each test specimen.

2—Measurement of the Total Transmission

The total transmission, that is to say the light intensity passing through the film over the visible spectrum, is measured on 50×50 mm test specimens using a Perkin-Elmer Lambda 35 spectrophotometer over a UV-visible [300 nm -900 nm] spectrum.

Two transmission values are recorded:
the transmission value at 550 nm, and
the mean transmission value over the entire visible spectrum, this value corresponding to the mean value of the transmissions over the visible spectrum. This value is measured every 10 nm.

3—Measurement of the Haze ratio

The Haze ratio is the ratio of the diffuse transmission to the total transmission. It is measured on 50×50 mm test specimens using a Perkin-Elmer Lambda 35 spectrophotometer over a UV-visible [300 nm-900 nm] spectrum.

The Haze ratio can be defined by the following formula:

$$H = \frac{Td}{Ti} \times 100$$

H: Haze (%)
Td: diffuse transmission (%)
Ti: total transmission (%)

4—Measurement of the Surface Resistance

The surface resistance (in Ω/□) can be defined by the following formula:

$$R = \frac{ρ}{e} = \frac{1}{σ . e}$$

e: thickness of the conductive layer (in cm),

σ: conductivity of the layer (in S/cm) ((σ=1/ρ), ρ: resistivity of the layer (in Ω·cm).

The surface resistance is measured on 20×20 mm test specimens using a Lucas Labs model, Pro4 system, 4-point surface conductivity meter, which injects a current between the external points. Gold contacts are deposited beforehand on the points by CVD in order to facilitate the measurements.

The measurements are carried out nine times on each test specimen.

### EXAMPLE

A composition A is prepared in the following way:

8.5 mg of Graphistrength U100® MWNTs carbon nanotubes are dispersed in 12.04 g of a dispersion of Clevios PH500® PEDOT:PSS, having a solids content of 1.2%, and in 13.25 g of DMSO using a high shear mixer (Silverson L5M) at a speed of 8000 revolutions/minute for 2 hours.

0.369 g of nanoparticles of polystyrene PS00400-NS (Ø=400 nm; Tg=108° C.) is added to the dispersion prepared above and then dispersed using a high shear mixer (Silverson L5M) at a speed of 8000 revolutions/minute for 20 minutes.

25.67 g of the dispersion of carbon nanotubes prepared above are added to 3.76 g of a Synthomer 5130® NBR (Nitrile-Butadiene Rubber) elastomer (Tg=−40° C.) in suspension in water (solids content of 45%). The mixture is subsequently stirred using a magnetic stirrer for 30 minutes.

The mixture obtained is subsequently filtered using a stainless steel mesh (Ø=50 μm), this being done in order to remove the dust and the large aggregates of carbon nanotubes which have not been dispersed.

The composition A prepared exhibits a carbon nanotubes/PEDOT:PSS ratio by weight of 1/17, a percentage by weight of carbon nanotubes of 0.5%, with respect to the weight of dry elastomer, and a solids content of 6%.

The composition A is subsequently applied to a glass substrate using a film drawer in order to form a film having a dry thickness (final thickness) of 2.2±0.2 μm, this film having been dried in an oven by following a temperature gradient ranging from 25 to 60° C. in 30 minutes, and then vulcanized at 150° C. for a time of 5 minutes.

The properties of the transparent film obtained are as follows:
surface resistance: R=198±24 Ω/□,
transmission: T=85% at 550 nm and Tₘₑₐₙ=80% between 300 and 900 nm.

### Counterexample 1

A composition B is prepared in the following way:

8.5 mg of Graphistrength U100® MWNTs carbon nanotubes are dispersed in 12.04 g of a dispersion of Clevios PH500® PEDOT:PSS, having a solids content of 1.2%, and in 13.25 g of DMSO using a high shear mixer (Silverson L5M) at a speed of 8000 revolutions/minute for 2 hours.

20.74 g of the dispersion of carbon nanotubes prepared above are added to 3.76 g of Synthomer 5130® NBR elastomer (Tg=−40° C.) in suspension in water (solids content of 45%). The mixture is subsequently stirred using a magnetic stirrer for 30 minutes.

The mixture obtained is subsequently filtered using a stainless steel mesh (Ø=50 μm), this being done in order to remove the dust and the large aggregates of carbon nanotubes which have not been dispersed.

The composition B prepared exhibits a carbon nanotubes/PEDOT:PSS ratio by weight of 1/17, a percentage by weight of carbon nanotubes of 0.5%, with respect to the weight of dry elastomer, and a solids content of 5%.

The composition B is subsequently applied to a glass substrate using a film drawer in order to form a film having a dry thickness (final thickness) of 2.5±0.2 μm, this film having been dried in an oven by following a temperature gradient ranging from 25 to 60° C. in 30 minutes, and then vulcanized at 150° C. for a time of 5 minutes.

The properties of the transparent film obtained are as follows:
surface resistance: R=283±25 Ω/□ (measured at the same transmission value as example 1, T=85% at 550 nm and Tₘₑₐₙ=80% between 300 and 900 nm),
transmission: T=82% at 550 nm and Tₘₑₐₙ=77% between 300 and 900 nm (measured at the same surface resistance value as example 1, R=198±24 Ω/□).

### Counterexample 2

A composition C is prepared in the following way:

0.225 g of nanoparticles of polystyrene PS00400-NS (Ø=400 nm; Tg=108° C.) is dispersed in 2 g of a Synthomer 5130® NBR elastomer (Tg=−40° C.) in suspension in water (solids content of 45%), to which 5.275 g of deionized water are added using a high shear mixer (Silverson L5M) at a speed of 1000 revolutions/minute for 10 minutes.

The composition C thus prepared exhibits a percentage by weight of polystyrene nanoparticles of 20%, with respect to the weight of dry elastomer, and a solids content of 15%.

The composition C is subsequently applied to a glass substrate using a film drawer in order to form a film having a dry thickness (final thickness) of 2.3±0.1 μm, this film having been dried in an oven by following a temperature gradient ranging from 25 to 60° C. in 30 minutes, and then vulcanized at 150° C. for a time of 5 minutes.

The properties of the transparent film obtained are as follows:
surface resistance: R>10⁸ Ω/□,
transmission: T=93% at 550 nm and Tₘₑₐₙ=92% between 300 and 900 nm.

1. A composition comprising:
(a) at least one dispersion or suspension of elastomer having a Tg<20° C. and/or of thermoplastic polymer having a Tg<20° C., and/or one polymer solution,
(b) at least one optionally substituted polythiophene conductive polymer,
(c) particles of crosslinked or noncrosslinked polymer chosen from functionalized or nonfunctionalized particles of polystyrene, of polycarbonate or of polymethylenemelamine, said particles of noncrosslinked polymer exhibiting a Tg>80° C., particles of glass, particles of silica and/or particles of metal oxides chosen from the following metal oxides: ZnO, MgO or MgAI₂O₄, or particles of borosilicate,
(d) conductive or semiconductive fillers which are nanometric, in dispersion or in suspension in water and/or in a solvent.

2. The composition as claimed in claim 1, in which the particles (c) are polymer particles having a multimodal distribution and a mean diameter of between 30 and 1000 nm.

3. The composition as claimed in claim 1, in which the particles (c) are polystyrene particles.

4. The composition as claimed in claim 1, in which the particles (c) are provided in the form of a powder or of a dispersion or of a suspension in water and/or in a polar organic solvent chosen from dimethyl sulfoxide (DMSO), N-methyl-2-pyrrolidone (NMP), ethylene glycol, dimethyl acetate (DMAc), dimethylformamide (DMF), acetone and alcohols, such as methanol, ethanol, butanol and isopropanol, or a mixture of these solvents.

5. The composition as claimed in claim 1, in which the ratio by weight of the elastomer and/or the thermoplastic polymer and/or the polymer (a) to the particles (c) can be between 0.1 and 10 000 and preferably between 1 and 1000.

6. The composition as claimed in claim 1, comprising at least one dispersion or suspension (a) of elastomer, said elastomer being chosen from polybutadiene, polyisoprene, acrylic polymers, polychloroprene, polyurethane, hexafluoropropene/difluoropropene/tetrafluoroethylene terpolymers, copolymers based on chlorobutadiene and on methacrylic acid or based on ethylene and on vinyl acetate, SBR, SBS, SIS and SEBS copolymers, isobutylene/isoprene copolymers, butadiene/acrylonitrile copolymers or butadiene/acrylonitrile/methacrylic acid terpolymers.

7. The composition as claimed in claim 6, in which said elastomer is selected from acrylic polymers, polychloroprene, SBR copolymers and butadiene/acrylonitrile copolymers.

8. The composition as claimed in claim 1, comprising at least one dispersion or suspension (a) of thermoplastic polymer, said thermoplastic polymer being chosen from polyesters, polyamides, polyurethanes, polypropylene, polyethylene, chlorinated polymers, such as polyvinyl chloride and polyvinylidene chloride, fluorinated polymers, such as polyvinylidene fluoride, polyacetates, polycarbonates, polyetheretherketones, polysulfides or ethylene/vinyl acetate copolymers.

9. The composition as claimed in claim 1, comprising at least one polymer solution (a), said polymer being chosen from polyvinyl alcohols, polyvinyl acetates, polyvinylpyrrolidones or polyethylene glycols.

10. The composition as claimed in claim 1, in which the conductive polymer (b) is poly(3,4-ethylenedioxythiophene)-poly(styrenesulfonate).

11. The composition as claimed in claim 1, in which the conductive polymer (b) is provided in the form of granules or of a dispersion or of a suspension in water and/or in a polar organic solvent chosen from dimethyl sulfoxide, N-methyl-2-pyrrolidone, ethylene glycol, dimethyl acetate, tetrahydrofuran or dimethylformamide.

12. The composition as claimed in claim 1, in which the fillers (d) are conductive fillers chosen from nanoparticles and/or nanofilaments of silver, of gold, of platinum and/or of ITO, and/or semiconductive fillers chosen from carbon nanotubes and graphene-based nanoparticles.

13. The composition as claimed in claim 1, in which the fillers (d) are carbon nanotubes in dispersion in water and/or in a solvent chosen from the following polar organic solvents: dimethyl sulfoxide, N-methyl-2-pyrrolidone, ethylene glycol, dimethyl acetate, dimethylformamide, acetone and alcohols, such as methanol, ethanol, butanol and isopropanol, or a mixture of these solvents.

14. A process for the preparation of a composition as claimed in claim 1, characterized in that it comprises the following stages:
(i) dispersing or suspending the nanometric conductive or semiconductive fillers (d) in water and/or in a solvent,
(ii) mixing the dispersion or the suspension obtained in stage (i) with a polythiophene conductive polymer (b),
(iii) adding particles of crosslinked or noncrosslinked polymer (c) to the dispersion obtained in stage (ii), said particles being chosen from functionalized or nonfunctionalized particles of polystyrene, of polycarbonate or of polymethylenemelamine, said particles of noncrosslinked polymer exhibiting a Tg>80° C., particles of glass, particles of silica and/or particles of metal oxides chosen from the following metal oxides: ZnO, MgO or MgAI₂O₄, or particles of borosilicate,
(iv) mixing the dispersion obtained during stage (iii) with at least one dispersion or suspension of elastomer having a Tg<20° C. and/or of thermoplastic polymer having a Tg<20° C., and/or one polymer solution (a).

15. A conductive transparent film, wherein it results from the film formation of at least one composition as defined according to claim 1.

16. The film as claimed in claim 15, wherein the thickness of said film is between 300 nm and 15 μm.

17. The film as claimed in claim 15, wherein it exhibits a mean transmission over a UV-visible [300 nm-900 nm] spectrum of greater than or equal to 78%.

18. The film as claimed in claim 15, wherein it exhibits a surface resistance of between 0.1 and 1000 Ω/□.

19. A process for the preparation of a film as defined according to Claim 15, comprising the following stages:
(i′) application to a support of a composition as defined according to claim 1, and
(ii′) evaporation of the solvents by drying at a temperature of between 25 and 80° C., said drying temperature necessarily having to be, when the particles of polymer (c) are particles of noncrosslinked polymer, less than the glass transition temperature Tg of said particles of noncrosslinked polymer present in the composition applied during stage (i′).

20. An article, comprising at least one flexible or rigid substrate coated with at least one composition as defined according to claim 1 or with a film as defined according to claim 15.

21. The article as claimed in claim 20, in which the substrate is chosen from glass, metal and flexible polymers.

22. The article as claimed in claim 21, in which the flexible polymers are chosen from polyethylene terephthalate, polyethylene naphthalate and polyethersulfone.

23. The article as claimed in claim 20, wherein it is chosen from the following electronic devices: photovoltaic cells, liquid crystal display panels, touch screens, flexible display panels, luminous display panels, electrophoretic display panels, organic light-emitting diodes, polymer light-emitting diodes and electromagnetic shielding devices.
